(19) United States
(12) Patent Application Publication
(10) Pub. No.: US 2026/0186635 A1
(43) Pub. Date: Jul. 2, 2026

(54) METHOD, APPARATUS, DEVICE, MEDIUM AND PRODUCT FOR MEDIA CONTENT PRESENTATION

(71) Applicant: Beijing Zitiao Network Technology Co., Ltd., Beijing (CN)

(72) Inventors: Mufeng Liu, Beijing (CN); Peiping Luo, Beijing (CN); Lukai Li, Beijing (CN); Ziheng Wang, Beijing (CN); Xuechao Wang, Beijing (CN); Cheng Liu, Beijing (CN); Shuqun Li, Beijing (CN); Shaojun Yue, Beijing (CN); Zilu Liu, Beijing (CN)

(21) Appl. No.: 19/431,964

(22) Filed: Dec. 23, 2025

(30) Foreign Application Priority Data
Dec. 30, 2024 (CN) 202411983053.X

(51) Int. Cl. G06F 3/0484

(52) U.S. Cl. CPC G06F 3/0484

(57) ABSTRACT

According to embodiments of the disclosure, a method, an apparatus, a device, a medium, and a product for media content presentation are provided. A method includes: presenting media content and a progress bar corresponding to the media content, a visual style of the progress bar being determined based on a content segment corresponding to a playback progress of the media content; and switching, in response to playback from a first content segment of the media content to a second content segment of the media content, the visual style of the progress bar from a first visual style corresponding to the first content segment to a second visual style corresponding to the second content segment.

### CROSS-REFERENCE

The present application claims priority to Chinese Patent Application No. 202411983053.X, filed on Dec. 30, 2024, and entitled “METHOD, APPARATUS, DEVICE, MEDIUM AND PRODUCT FOR MEDIA CONTENT PRESENTATION”, which is incorporated herein by reference in its entirety.

### FIELD

Example embodiments of the present disclosure generally relate to the field of computers, and in particular, to a method, an apparatus, a device, and a computer-readable storage medium for media content presentation.

### BACKGROUND

With the rapid development of Internet technologies, various media contents are becoming increasingly rich and diverse. Various applications for presenting media content have become important tools for users to obtain information, entertain and learn.

In order to enhance the intuitive experience of the user when obtaining media content, various media presentation applications usually provide a variety of interaction components, such as a playback control area, a volume adjustment button, a time progress bar, and the like. As one of the core elements in the media playback interface, the progress bar is not only used to display the playback progress of the media content, but also provides the user with a certain content navigation function.

### SUMMARY

In a first aspect of the present disclosure, a method for media content presentation is provided. The method includes: presenting media content and a progress bar corresponding to the media content, a visual style of the progress bar being determined based on a content segment corresponding to a playback progress of the media content; and switching, in response to playback from a first content segment of the media content to a second content segment of the media content, the visual style of the progress bar from a first visual style corresponding to the first content segment to a second visual style corresponding to the second content segment.

In a second aspect of the present disclosure, an apparatus for media content presentation is provided. The apparatus includes: a presentation module configured to present media content and a progress bar corresponding to the media content, a visual style of the progress bar being determined based on a content segment corresponding to a playback progress of the media content; and a visual style processing module configured to switch, in response to playback from a first content segment of the media content to a second content segment of the media content, the visual style of the progress bar from a first visual style corresponding to the first content segment to a second visual style corresponding to the second content segment.

In a third aspect of the present disclosure, an electronic device is provided. The device includes at least one processor; and at least one storage unit, the at least one storage unit being coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium has computer-executable instructions stored thereon which are executable by a processor to implement the method of the first aspect.

In a fifth aspect of the present disclosure, a computer-executable instruction product is provided. The computer-executable instruction product is tangibly stored in a computer storage medium and includes computer-executable instructions which, when executed by a device, cause the device to perform the method of the first aspect.

It would be appreciated that the content described in this Summary section is neither intended to identify key or essential features of embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of embodiments of the present disclosure will become more apparent in combination with the drawings and with reference to the following detailed description. In the drawings, the same or similar reference symbols refer to the same or similar elements, where:

FIG. 1A shows a schematic diagram of an example environment in which embodiments of the present disclosure may be implemented;

FIG. 1B shows a schematic diagram of an example interface for media content presentation;

FIG. 2A shows a schematic diagram of an example interface for media content presentation according to some embodiments of the present disclosure;

FIG. 2B shows a schematic diagram of an example progress bar according to some embodiments of the present disclosure;

FIG. 3A to FIG. 3B show schematic diagrams of example interfaces for media content presentation according to some other embodiments of the present disclosure;

FIG. 3C shows a schematic diagram of a process of switching a visual style of a progress bar according to some embodiments of the present disclosure;

FIG. 4 shows a flowchart of a process for media content presentation according to some embodiments of the present disclosure;

FIG. 5 shows a schematic structural block diagram of an apparatus for media content presentation according to some embodiments of the present disclosure; and

FIG. 6 shows a block diagram of an electronic device in which one or more embodiments of the present disclosure may be implemented.

### DETAILED DESCRIPTION

Embodiments of the present disclosure will be described in more detail below with reference to the drawings. Although some embodiments of the present disclosure are shown in the drawings, it would be appreciated that the present disclosure may be implemented in various forms and should not be construed as limited to the embodiments set forth herein. On the contrary, these embodiments are provided for a more thorough and complete understanding of the present disclosure. It would be appreciated that the drawings and embodiments of the present disclosure are only for illustrative purposes, and are not intended to limit the protection scope of the present disclosure.

In the description of embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other definitions, either explicit or implicit, may also be included below.

Herein, unless explicitly stated, performing a step “in response to A” does not mean that the step is performed immediately after “A”, but may include one or more intermediate steps.

It may be understood that the data involved in the technical solution (including but not limited to the data itself, acquisition or use of the data) should comply with requirements of corresponding laws, regulations and related provisions.

It may be understood that before using the technical solution disclosed in the embodiments of the present disclosure, the user should be informed of the type, range of use, use scenarios, etc., of personal information involved in the present disclosure in an appropriate manner and the authorization of the user should be obtained in accordance with relevant laws and regulations.

For example, in response to receiving an active request from the user, prompt information is sent to the user to clearly inform the user that the requested operation will require access to and use of the user's personal information, so that the user may independently choose whether to provide the personal information to software or hardware, such as an electronic device, an application, a server or a storage medium, that performs the operations of the technical solution of the present disclosure based on the prompt information.

As an optional but non-restrictive implementation, in response to receiving the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure, and other methods that satisfy the relevant laws and regulations may also be applied to the implementations of the present disclosure.

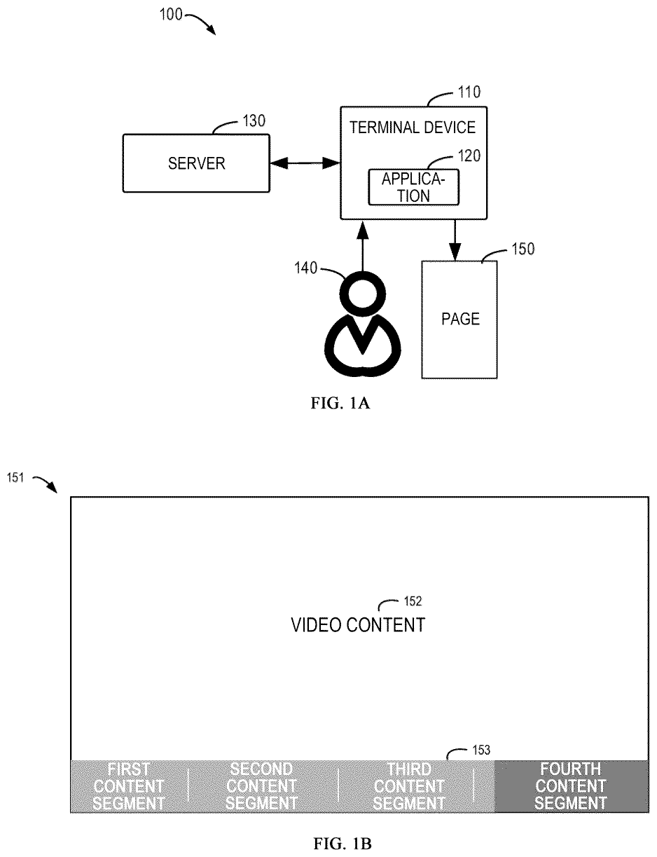

FIG. 1A shows a schematic diagram of an example environment 100 in which the embodiments of the present disclosure may be implemented. In this example environment 100, an application 120 is installed on a terminal device 110. A user 140 may interact with the application 120 via the terminal device 110 and/or an attachment device of the terminal device 110. The application 120 may be a content presentation application (e.g., a video playback application), an online shopping application, or any other suitable application.

In the environment 100 of FIG. 1A, if the application 120 is active, the terminal device 110 may present a 120, such as a content presentation page, a content creation page, a content publishing page, a message page, a personal homepage, and so on. The application 120 may provide a content viewing function to view various contents published in the application 120. Via a corresponding page, the application 120 may provide the user 140 with online content such as media content. Via an appropriate method, such as clicking or selecting a page element, the application 120 may also provide the user 140 with switching between a plurality of pages for presenting content. The application 120 may also have a publishing function, allowing the user 140 to publish the created media content. As used herein, “media content” includes one or more types of content, such as images, image sets, videos, animated images, audio, text, and so on.

In some embodiments, the terminal device 110 communicates with a server 130 to enable provision of services of the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination of the foregoing, including the accessories and peripherals of these devices, or any combination thereof. In some embodiments, the terminal device 110 may also support any type of user-specific interface (such as “wearable” circuitry, etc.). The server 130 may be various types of computing systems/servers that may provide computing power, including but not limited to mainframes, edge computing nodes, computing devices in cloud environments, and so on.

It would be appreciated that the structure and functions of the elements in the environment 100 are described for illustrative purposes only, without suggesting any limitation to the scope of the present disclosure.

As briefly mentioned above, with the rapid development of multimedia technologies, various media content playback applications have become important tools for people to obtain information, entertain and learn in their daily lives. While providing high-quality content, these applications also continuously optimize the interface design and interaction experience to meet the users' needs for personalization and convenience.

In a media playback scenario, as one of the core interaction components, progress bars are widely used in videos, audios, and audio-visual content (such as animations or interactive media). The progress bar not only intuitively presents the playback progress of the content, but also helps the user to quickly perceive and filter the content of interest through segment marks or structured information. For example, in the case where the video or audio content is divided into multiple segments, the progress bar usually adopts a segmented design to clearly mark the start and end positions of each segment, so as to facilitate the user to quickly navigate between different parts of the content. However, in some applications for presenting media content, the visual style of the progress bar is usually fixed and cannot be dynamically adjusted with the change of the playback content.

As an example, FIG. 1B shows a schematic diagram of an example interface 151 for media content presentation. As shown in FIG. 1B, in a video playback scenario, the style of the progress bar 153 may not match the overall style of the video content 152, resulting in a visual fragmentation. In addition, as the video content 152 is played, for example, when switching from one segment to another, the fixed style cannot intuitively prompt the user of the change of the playback content, which limits the improvement of user experience to some extent. As requirements of the user for the aesthetics and interactivity of the playback interface gradually increase, it is worth paying attention to how to enable the presentation of media content to dynamically adapt to the change of content features.

In view of this, according to embodiments of the present disclosure, an improved solution for media content presentation is proposed. The solution includes presenting media content and a progress bar corresponding to the media content, a visual style of the progress bar is determined based on a content segment corresponding to a playback progress of the media content. And in response to playback from a first content segment of the media content to a second content segment of the media content, the visual style of the progress bar is switched from a first visual style corresponding to the first content segment to a second visual style corresponding to the second content segment.

In this way, by enabling the visual style of the progress bar to dynamically change based on the dynamic media content features, different styles and structures may be automatically adapted according to the playback content, which not only improves the coordination of the media content presentation interface, but also significantly improves the user's intuitive perception and interaction experience of content playback.

Some example embodiments of the present disclosure will be described below with continued reference to the drawings. It would be appreciated that the pages shown in the drawings are only examples, and various page designs may actually exist. The various graphic elements in the page may have different arrangements and different visual representations, one or more of which may be omitted or replaced, and there may also be one or more other elements. The embodiments of the present disclosure are not limited in this regard. In addition, in the following, the example embodiments will be mainly described with respect to the terminal device 110. It would be appreciated that the actions described with respect to the terminal device 110 may be performed by the application 120 on the terminal device 110, or may be performed by the application 120 in cooperation with its server (for example, the server 130).

In embodiments of the present disclosure, when a page 150 is provided for the user, the terminal device 110 may present media content and a progress bar corresponding to the media content on the page 150.

The media content refers to the playback content presented by the terminal device 110 on the page 150. The progress bar is a visual component used to display the playback progress or browsing progress of the media content.

In some embodiments, the media content may not be limited to videos, but may also include other multimedia forms, such as audio, audio books, interactive content (such as multimedia presentations, interactive tutorials or plot content in games), or other content with structured information or dynamic information.

In some embodiments, the progress bar may also refer to interaction components that convey the state of the media content or changes in information through visual feedback, such as time axes, navigation bars, and so on.

In embodiments of the present disclosure, in addition to the playback progress is displayed, the visual style of the progress bar is also determined based on the content segment corresponding to the playback progress of the media content. When the terminal device 110 determines that the playback progress of the media content has changed, it may control the visual style of the progress bar in the page 150 to also switch accordingly, the visual style corresponding to the current playback content segment is presented.

The playback progress is used to indicate a proportion of the media content that has been played in the overall media content. In some embodiments, in the case where the media content may be pre-divided into multiple segments (for example, segments corresponding to multiple chapters), the playback progress may indicate not only the specific current playback progress, but also the content segment or chapter corresponding to the current playback progress.

In some embodiments, in the case where the media content itself has segment divisions, the visual style determined according to the segments refers to the visual style determined according to the content segments divided by the media content itself. In some embodiments, if the media content does not have obvious segments or structured information, the media content may also be evenly divided into multiple content segments according to a predetermined time length, and then the corresponding visual style is determined based on the divided content segments. For example, the corresponding visual style may be determined according to a segment per 10 seconds or 20 seconds. In this way, according to the embodiments of the present disclosure, the style of the progress bar may be dynamically adjusted based on the characteristics of the media content in different time periods.

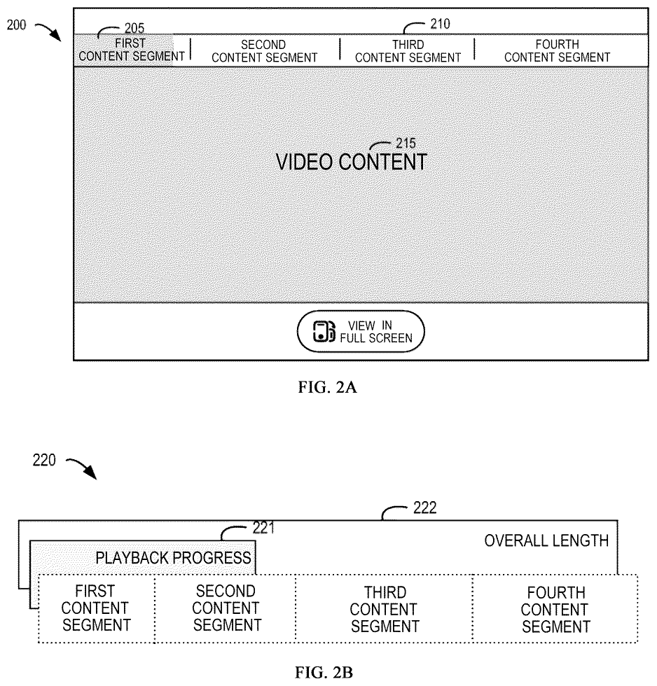

As an example, FIG. 2A shows a schematic diagram of an example interface 200 for media content presentation according to some embodiments of the present disclosure. As shown in FIG. 2A, the terminal device 110 may control to present a progress bar 210 and video content 215 in the interface 200.

When the progress bar is displayed, the progress bar may include multiple parts, and at least one of the multiple parts corresponds to a content segment of the media content that has been played, and at least one part corresponds to a content segment of the media content that has not been played. The length of the part of the progress bar corresponding to the played content segment is determined by the proportion of the played content segment to the total length of the entire media content. Therefore, the length of the part of the progress bar corresponding to the played content segment will change continuously with the playback progress (for example, it will increase continuously with the increase of the playback progress). Correspondingly, the part of the progress bar corresponding to the unplayed content segment is used to indicate the length occupied by the unplayed content segment in the entire media content. The length of the part of the progress bar corresponding to the unplayed content segment also changes continuously with the playback progress (for example, it decreases continuously with the increase of the playback progress).

Referring to FIG. 2A, the progress bar 210 may include a part of the progress bar 205 (which may also be understood as the part of the progress bar 210 corresponding to the played content segment or the playback progress of the media content). The part of the progress bar 205 changes dynamically with the playback progress of the media content, and its visual style is determined according to the content segment corresponding to the current playback progress. In some embodiments, the visual style of the part of the progress bar 205 is determined based on the content segment corresponding to the playback progress of the media content. For example, if the first content segment of the video content 215 is played in the interface 200, the visual style of the part of the progress bar 205 matches the theme or visual features of the video content of the first content segment.

In some embodiments, the visual style of the progress bar may indicate the color of the progress bar. For example, the color of the part of the progress bar (the part of the progress bar corresponding to the playback progress of the media content) may change dynamically with the playback progress of the media content. In other embodiments, the visual style of the progress bar may also indicate more, less or other styles such as shape, filling pattern, transparency, texture, light effect and shadow, etc.

In some embodiments, the visual style of the part of the progress bar corresponding to the unplayed content in the progress bar remains unchanged. Referring to FIG. 2A, the progress bar 210 also includes a part of the progress bar corresponding to the unplayed content, and the visual style of this part remains constant and does not change with the change of the playback progress. For example, the visual style of the part of the progress bar corresponding to the unplayed content may adopt a single color or texture to ensure that the overall visual effect is simple and consistent, while the user 140 is allowed to clearly distinguish between the played and unplayed content.

As an example, FIG. 2B shows a schematic diagram of an example progress bar 220 according to some embodiments of the present disclosure. As shown in FIG. 2B, the progress bar 220 may include an overall length 222 of the media content, which is used to present the overall structural information of the progress bar, thereby helping the user to understand the structural information of the media content at a glance.

The progress bar 220 may also include a playback progress part 221 of the media content, which is used to reflect the real-time progress of the user 140 watching the media content. According to embodiments of the present disclosure, the terminal device 110 may control the visual style of the playback progress part 221 to dynamically change with the content segment currently being played, so that the visual style of the progress bar matches the content segment currently being played, and the user may visually perceive the content change from the progress bar, thereby improving the user experience.

In some examples, the segment information (such as the range and description information of each content segment) of the video content may be displayed in the progress bar 220 as a cell in a predetermined visual style. As the current playback progresses to a certain content segment, the visual style of the progress bar segment area corresponding to the playback progress in the progress bar is presented in a predetermined visual style.

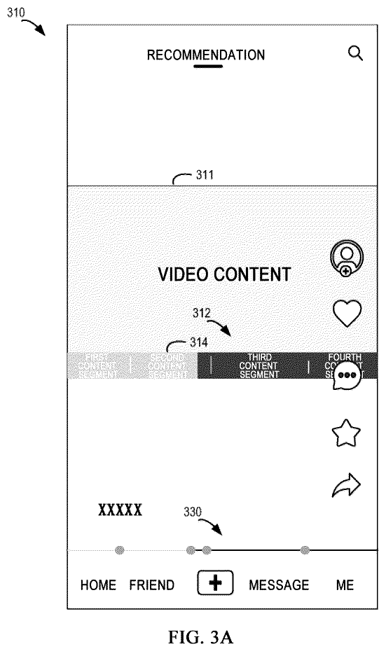

For ease of understanding, the solution for media content presentation of the present disclosure will be described below with reference to FIG. 3A and FIG. 3B. FIG. 3A and FIG. 3B show schematic diagrams of example interfaces 310 and 320 for media content presentation according to other embodiments of the present disclosure. The example interfaces 310 and 320 shown in FIG. 3A and FIG. 3B may be any page of the application 120. Although it is described that these embodiments may be implemented at the terminal device 110 in FIG. 1A, especially at the application client of the terminal device 110, in other embodiments, the terminal device 110 may perform these operations with the assistance of the server 130.

In embodiments of the present disclosure, if it is detected that the playback progresses from a first content segment of multiple content segments of the media content to a second content segment of the multiple content segments, the terminal device 110 may switch the visual style of the progress bar from a first visual style corresponding to the first content segment to a second visual style corresponding to the second content segment. The first visual style is determined based on the first content segment, and the second visual style is determined based on the second content segment.

An example of presenting media content in a content interface, such as a recommendation page, is described below with reference to FIG. 3A to FIG. 3B. In the example shown in FIG. 3A, the terminal device 110 presents video content 311 corresponding to the second content segment of the media content (such as video content) in the interface 310. At this time, the progress bar part 314 corresponding to the playback progress in the progress bar 312 has a visual style corresponding to the video content 311 of the second content segment.

In some embodiments, if the terminal device 110 detects that the media content presented in the interface is switched from the first content segment to the second content segment, it switches the visual style of the progress bar from the first visual style corresponding to the first content segment to the second visual style corresponding to the second content segment. In the example interface 320 shown in FIG. 3B, as the current playback progress corresponds to the video content 321 corresponding to the third content segment of the media content, the terminal device 110 switches the visual style of the progress bar 312 to the visual style corresponding to the video content 321 of the third content segment. At this time, the progress bar part 322 corresponding to the playback progress in the progress bar 312 has a visual style corresponding to the video content 321 of the third content segment.

In some embodiments, the aforementioned progress bar may be referred to as a first progress bar, and the interface for playing the target media may also include a second progress bar corresponding to the media content, where the second progress bar may be presented in a predetermined visual style. As shown in FIG. 3A and FIG. 3B, in addition to the progress bar 312, a progress bar 330 may also be presented, where the visual style (for example, color style) of the progress bar 330 may remain unchanged.

FIG. 3C shows a schematic diagram of a process 300C of switching the visual style of the progress bar according to some embodiments of the present disclosure.

At block 331, the terminal device 110 may obtain segmentation information and visual information corresponding to the media content.

The segmentation information indicates the division of the multiple content segments in the media content. In some embodiments, as mentioned above, the media content may be divided into several content segments, where each content segment may correspond to one logical content segment. For example, the video is divided into a “first content segment”, a “second content segment”, and so on. The specific segmentation point may be based on the content segment mark added by the video creator, or automatic analysis (such as through time, key frame content change, etc.). Such segmentation information may depend on the configuration of the creator of the media content. In other embodiments, the division of the content segments may also be the automatic division of the media content according to a predetermined time length.

The visual information indicates the visual style of each of the multiple content segments. In some embodiments, in response to determining a content segment in the media content, the visual style corresponding to the content segment may be determined, until the visual style corresponding to each content segment of the media content is determined. For example, when the user uploads a video and adds a content segment, the visual style corresponding to the content of each content segment is predetermined, so as to ensure that real-time calculation is not required when the video is subsequently presented, thereby improving the performance of content presentation.

In some embodiments, the terminal device 110 may obtain the segmentation information and the visual information corresponding to the media content from the server 130. That is, the visual style corresponding to each content segment of the media content may be determined by the server 130. Certainly, it may be understood that the segmentation information and visual information of each content segment may also be determined locally at the terminal device 110. In the following, for the convenience of discussion, the case where the server 130 determines the visual information is taken as an example for description.

In some embodiments, after the segmentation of the media content is determined, the server 130 may select at least one reference frame from a target content segment, where the target content segment may be any content segment in the media content, including the first content segment or the second content segment. Then, the server 130 may determine the visual style corresponding to the target content segment based on the visual style corresponding to the at least one reference frame.

In some embodiments, the visual style corresponding to the target content segment indicates a color value. The server 130 may determine the color value indicated by the visual style corresponding to the target content segment based on the pixel value of each pixel in the at least one reference frame.

As an example, when the creator adds a content segment to the media content, the server 130 may extract the start frame of the content segment (for example, a video segment) as a reference frame, and read all pixel values of the reference frame. Assuming that the color information of the frame is represented by an RGB format, the server 130 may calculate the average value of the RGB values of the pixel values to obtain the overall color value T1 (R0, G0, B0) as the color value of the visual style corresponding to the current content segment, where R0, G0, and B0 are the average values of the red, green, and blue channels, respectively.

In some embodiments, the server 130 may convert the pixel value of each pixel in the at least one reference frame into a format including at least one of saturation and brightness. For example, the server 130 may convert the pixel value of each pixel in the at least one reference frame into a format including saturation, and only enhance or weaken the vividness of the color by correcting the saturation. The server 130 may also convert the pixel value of each pixel in the at least one reference frame into a format including saturation, and only adjust the brightness to make the color brighter or darker while maintaining the original hue and saturation. Alternatively or additionally, the server 130 may also convert the pixel value of each pixel in the at least one reference frame into a format including saturation and brightness, considering the overall visual consistency of the reference frame.

As an example, the server 130 converts the color value T1 (R0, G0, B0) in the RGB format into the color value T1 (H0, S0, B0) in the HSB format for subsequent color correction adjustment, where H0, S0, and B0 represent hue, saturation, and brightness, respectively.

Further, the server 130 may respectively perform a correction operation on the saturation and the brightness in the color value, so that the corrected saturation and brightness respectively fall within their threshold ranges. Then, the server 130 may determine the corrected color value as the color value indicated by the visual style.

As an example, the server 130 may correct the color value T1 (H0, S0, B0) to obtain the corrected color value T1 (H1, S1, B1) as follows:

$$\{ \begin{matrix}{H}_{1} = {H}_{0} \\ {S}_{1} = min ( {S}_{0} , 30 ) \\ {B}_{1} = min ( max ( {B}_{0} , 10 ) , 330 )\end{matrix} \qquad ( 1 )$$

where H1=H0, that is, the hue remains unchanged; S1=min (S0, B0), the saturation is limited to within 30 to avoid the color being too strong; B1=min (max (B0, 10), 30), the brightness range is limited to between [10, 30] to prevent the color from being too dark or too bright. The original color value is optimized through the correction operation, so that the visual style of the progress bar is more suitable for display on the user interface. Certainly, it would be appreciated that the specific values of the threshold ranges of the saturation and the brightness here are only examples, and any other value ranges may be configured as needed in actual applications.

The server 130 may convert the T1 (H1, S1, B1), after adjusting color, back to the RGB format as the color value T1 (R, G, B) of the visual style corresponding to the first content segment. By performing the above operation of determining the color value of the visual style corresponding to the content segment based on the at least one reference frame for the video content of each content segment, the visual information indicating the visual style of each content segment is finally obtained, that is, the color value array indicating the visual styles corresponding to all content segments, which is expressed as: Colors [T1 (R, G, B), T2 (R, G, B), . . . , TN (R, G, B)].

Continuing to refer to FIG. 3C, at block 332, the terminal device 110 determines a second visual style corresponding to the second content segment based on the segmentation information and the visual information.

In some embodiments, based on the obtained segmentation information and visual information, the terminal device 110 determines the second visual style of the progress bar. Since the segmentation information and visual information of the media content are gradually determined when the target content segment (for example, the user adds the first chapter to the contributed video) is determined, the terminal device 110 may directly obtain the segmentation information and the visual information during the presentation of the target video content, and determine the corresponding visual style. In this way, it may avoid the consumption of computing resources caused by re-determining the visual style (such as calculating the color value of the progress bar) every time the media content is presented, thereby ensuring the smoothness of playback.

At block 333, the terminal device 110 switches the visual style of the progress bar from the current first visual style to the second visual style.

In some embodiments, when the terminal device 110 determines that the playback progress of the video crosses the boundary point between the two content segments (that is, the boundary point of the content segments indicated by the segmentation information), the visual style switching operation of the progress bar is triggered. According to the obtained visual information, the terminal device 110 switches the progress bar style from the style corresponding to the video content of the first content segment to the style corresponding to the video content of the second content segment, for example, the progress bar from the main color red of the video content of the first content segment may be switched to the main color blue of the video content of the second content segment. Moreover, in order to improve the visual experience of the user, the style switching operation may be completed by gradation or animation, for example, the terminal device 110 smoothly transitions the color of the progress bar from red to blue within 1 second.

In summary, according to various embodiments of the present disclosure, by enabling the visual style of the progress bar to dynamically change based on the dynamic media content features, different styles and structures may be automatically adapted according to the playback content, which not only improves the coordination of the media content presentation interface, but also significantly improves the user's intuitive perception and interaction experience of content playback.

### Example Process

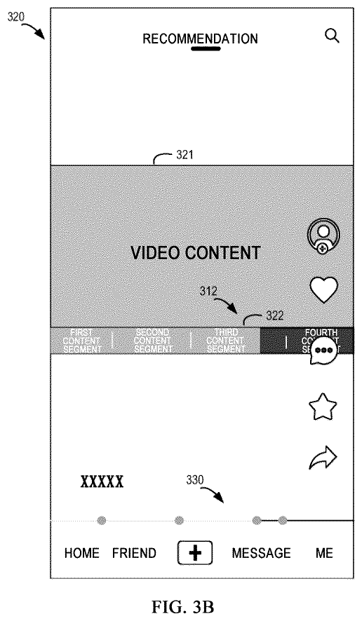

FIG. 4 shows a flowchart of a process 400 for media content presentation according to some embodiments of the present disclosure. The process 400 may be implemented at the terminal device 110. The process 400 is described below with reference to FIG. 1A.

At block 410, the terminal device 110 presents media content and a progress bar corresponding to the media content, a visual style of the progress bar is determined based on a content segment corresponding to a playback progress of the media content.

At block 420, the terminal device 110 switches, in response to playback from a first content segment of the media content to a second content segment of the media content, the visual style of the progress bar from a first visual style corresponding to the first content segment to a second visual style corresponding to the second content segment.

In some embodiments, a visual style of a progress bar part corresponding to the playback progress in the progress bar is determined based on the content segment corresponding to the playback progress of the media content.

In some embodiments, the process 400 further includes: obtaining segmentation information and visual information corresponding to the media content, the segmentation information indicating a division of content segments in the media content, and the visual information indicating a visual style of each of the content segments; determining the second visual style corresponding to the second content segment based on the segmentation information and the visual information; and switching the visual style of the progress bar from the first visual style to the second visual style.

In some embodiments, the visual style corresponding to a target content segment in the media content is determined by: selecting at least one reference frame from the target content segment; and determining the visual style corresponding to the target content segment based on a visual style corresponding to the at least one reference frame, where the target content segment includes the first content segment or the second content segment.

In some embodiments, the visual style corresponding to the target content segment indicates a color value, and the process 400 further includes: determining the color value indicated by the visual style corresponding to the target content segment based on a pixel value of a respective pixel in the at least one reference frame.

In some embodiments, the process 400 further includes: converting the pixel value of the respective pixel in the at least one reference frame into a color value including hue, saturation, and brightness; performing a correction operation for the saturation and the brightness in the color value respectively, such that the corrected saturation and brightness respectively fall within a respective threshold range; and determining the corrected color value as the color value indicated by the visual style.

In some embodiments, the media content includes a video.

### Example Apparatus and Device

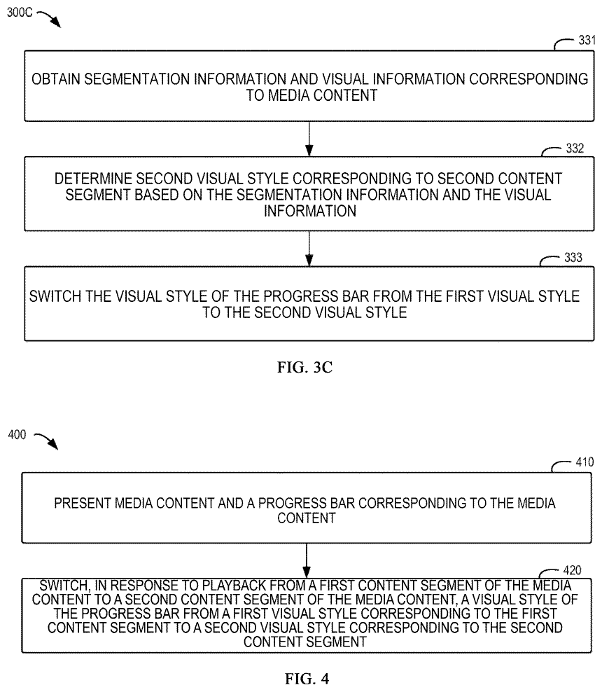

FIG. 5 shows a schematic structural block diagram of an apparatus 500 for media content presentation according to some embodiments of the present disclosure. The apparatus 500 may be implemented as or included in the terminal device 110. Each module/component in the apparatus 500 may be implemented by hardware, software, firmware, or any combination thereof.

As shown in the figure, the apparatus 500 includes a presentation module 510 configured to present media content and a progress bar corresponding to the media content, a visual style of the progress bar being determined based on a content segment corresponding to a playback progress of the media content; and a visual style processing module 520 configured to switch, in response to playback from a first content segment of the media content to a second content segment of the media content, the visual style of the progress bar from a first visual style corresponding to the first content segment to a second visual style corresponding to the second content segment.

In some embodiments, a visual style of a progress bar part corresponding to the playback progress in the progress bar is determined based on the content segment corresponding to the playback progress of the media content.

In some embodiments, the visual style processing module 520 is further configured to obtain segmentation information and visual information corresponding to the media content, the segmentation information indicates a division of content segments in the media content, and the visual information indicates a visual style of each of the content segments; determine the second visual style corresponding to the second content segment based on the segmentation information and the visual information; and switch the visual style of the progress bar from the first visual style to the second visual style.

In some embodiments, the apparatus 500 further includes a visual style determination module configured to select at least one reference frame from a target content segment; and determine a visual style corresponding to the target content segment based on a visual style corresponding to the at least one reference frame, where the target content segment includes the first content segment or the second content segment.

In some embodiments, the visual style corresponding to the target content segment indicates a color value. The visual style determination module is further configured to determine the color value indicated by the visual style corresponding to the target content segment based on a pixel value of a respective pixel in the at least one reference frame.

In some embodiments, the visual style determination module is further configured to convert the pixel value of the respective pixel in the at least one reference frame into a color value including hue, saturation, and brightness; performing a correction operation for the saturation and the brightness in the color value respectively, such that the corrected saturation and brightness respectively fall within a respective threshold range; and determine the corrected color value as the color value indicated by the visual style.

In some embodiments, the media content includes a video.

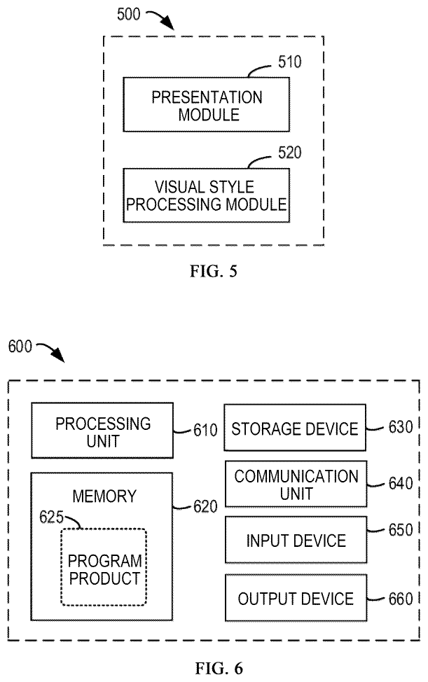

FIG. 6 shows a block diagram of an electronic device 600 in which one or more embodiments of the present disclosure may be implemented. It would be appreciated that the electronic device 600 shown in FIG. 6 is only illustrative, and should not constitute any limitation on the functions and scope of the embodiments described herein. The electronic device 600 shown in FIG. 6 may be configured to implement the terminal device 110 in FIG. 1A.

As shown in FIG. 6, the electronic device 600 is in the form of a general-purpose electronic device. The components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and may execute various processes based on the programs stored in the memory 620. In a multi-processor system, multiple processing units execute computer-executable instructions in parallel to improve the parallel processing capability of the electronic device 600.

The electronic device 600 typically includes multiple computer storage medium. Such medium may be any available medium accessible by the electronic device 600, including, but not limited to, volatile and non-volatile medium, removable and non-removable medium. The memory 620 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine-readable medium such as a flash drive, a disk, or any other medium, which may be used to store information and/or data (such as training data for training) and may be accessed within the electronic device 600.

The electronic device 600 may further include additional removable/non-removable, volatile/non-volatile memory medium. Although not shown in FIG. 6, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 620 may include a computer program product 625, which has one or more program modules configured to perform various methods or acts of the various embodiments of the present disclosure.

The communication unit 640 enables communication with other electronic devices via the communication medium. Additionally, the functions of the components of the electronic device 600 may be implemented by a single computing cluster or multiple computing machines, which may communicate via communication connections. Therefore, the electronic device 600 may use a logical connection with one or more other servers, a network personal computer (PC) or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) such as a storage device, a display device, etc., as needed via the communication unit 640, communicate with one or more devices that enable the user to interact with the electronic device 600, or communicate with any devices (e.g., a network card, a modem, etc.) that enable the electronic device 600 to communicate with one or more other electronic devices. Such communication may be performed via input/output (I/O) interfaces (not shown).

According to an illustrative implementation of the present disclosure, there is provided a computer-readable storage medium having computer-executable instructions stored thereon, where the computer-executable instructions are executed by a processor to implement the method described above. According to an illustrative implementation of the present disclosure, there is further provided a computer program product, the computer program product is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices, and computer program products implemented according to the present disclosure. It would be appreciated that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that when the instructions are executed by the processing unit of the computer or other programmable data processing apparatus, an apparatus for implementing the functions/acts specified in one or more blocks of the flowcharts and/or block diagrams is produced. These computer-readable program instructions may also be stored in a computer-readable storage medium, these instructions enable the computer, the programmable data processing apparatus, and/or other devices to work in a specific manner, and thus the computer-readable medium storing the instructions includes a manufactured product, which includes instructions for implementing various aspects of the functions/acts specified in one or more blocks of the flowcharts and/or block diagrams.

The computer-readable program instructions may be loaded onto a computer, another programmable data processing apparatus, or other devices, such that a series of operations and steps are performed on the computer, the another programmable data processing apparatus, or other devices to produce a computer-implemented process, thereby enabling the instructions executed on the computer, the another programmable data processing apparatus, or other devices to implement the functions/acts specified in one or more blocks of the flowcharts and/or block diagrams.

The flowcharts and block diagrams in the drawings show the possibly implemented architectures, functions, and operations of the system, method and computer program product according to multiple implementations of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It would also be noted that each block in the block diagrams and/or flowcharts, and combinations of the blocks in the block diagrams and/or flowcharts, may be implemented by a special-purpose hardware-based system that performs the specified functions or acts, or may be implemented by a combination of special-purpose hardware and computer instructions.

The implementations of the present disclosure have been described above, and the above description is illustrative, non-exhaustive, and not limited to the disclosed implementations. Without departing from the scope of the described implementations, many modifications and changes would be apparent to those of ordinary skill in the art. The terms used herein are chosen to best explain the principles of the implementations, the practical applications, or improvements to the technologies in the market, or to enable other those of ordinary skill in the art to understand the implementations disclosed herein.

1. A method for media content presentation, comprising:
presenting media content and a progress bar corresponding to the media content, a visual style of the progress bar being determined based on a content segment corresponding to a playback progress of the media content; and
switching, in response to playback from a first content segment of the media content to a second content segment of the media content, the visual style of the progress bar from a first visual style corresponding to the first content segment to a second visual style corresponding to the second content segment.

2. The method of claim 1, wherein a visual style of a part of the progress bar in the progress bar is determined based on the content segment corresponding to the playback progress of the media content.

3. The method of claim 1, wherein switching the visual style of the progress bar from the first visual style corresponding to the first content segment to the second visual style corresponding to the second content segment comprises:
obtaining segmentation information and visual information corresponding to the media content, the segmentation information indicating a division of a plurality of content segments in the media content, and the visual information indicating a visual style of each of the plurality of content segments;
determining the second visual style corresponding to the second content segment based on the segmentation information and the visual information; and
switching the visual style of the progress bar from the first visual style to the second visual style.

4. The method of claim 1, wherein a visual style corresponding to a target content segment in the media content is determined by:
selecting at least one reference frame from the target content segment; and
determining the visual style corresponding to the target content segment based on a visual style corresponding to the at least one reference frame,
wherein the target content segment comprises the first content segment or the second content segment.

5. The method of claim 4, wherein the visual style corresponding to the target content segment indicates a color value, and wherein determining the visual style corresponding to presenting the target content segment comprises:
determining the color value indicated by the visual style corresponding to the target content segment based on a pixel value of a respective pixel in the at least one reference frame.

6. The method of claim 5, wherein determining the color value indicated by the visual style corresponding to the target content segment comprises:
converting the pixel value of the respective pixel in the at least one reference frame into at least one of saturation or brightness;
performing a correction operation for the at least one of the saturation or the brightness respectively, such that the at least one of the corrected saturation or brightness falls within a respective threshold range; and
determining the color value indicated by the visual style based on the at least one of the corrected saturation or brightness.

7. The method of claim 1, wherein the media content comprises a video.

8. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
presenting media content and a progress bar corresponding to the media content, a visual style of the progress bar being determined based on a content segment corresponding to a playback progress of the media content; and
switching, in response to playback from a first content segment of the media content to a second content segment of the media content, the visual style of the progress bar from a first visual style corresponding to the first content segment to a second visual style corresponding to the second content segment.

9. The electronic device of claim 8, wherein a visual style of a part of the progress bar in the progress bar is determined based on the content segment corresponding to the playback progress of the media content.

10. The electronic device of claim 8, wherein switching the visual style of the progress bar from the first visual style corresponding to the first content segment to the second visual style corresponding to the second content segment comprises:
obtaining segmentation information and visual information corresponding to the media content, the segmentation information indicating a division of a plurality of content segments in the media content, and the visual information indicating a visual style of each of the plurality of content segments;
determining the second visual style corresponding to the second content segment based on the segmentation information and the visual information; and
switching the visual style of the progress bar from the first visual style to the second visual style.

11. The electronic device of claim 8, wherein a visual style corresponding to a target content segment in the media content is determined by:
selecting at least one reference frame from the target content segment; and
determining the visual style corresponding to the target content segment based on a visual style corresponding to the at least one reference frame,
wherein the target content segment comprises the first content segment or the second content segment.

12. The electronic device of claim 11, wherein the visual style corresponding to the target content segment indicates a color value, and wherein determining the visual style corresponding to presenting the target content segment comprises:
determining the color value indicated by the visual style corresponding to the target content segment based on a pixel value of a respective pixel in the at least one reference frame.

13. The electronic device of claim 12, wherein determining the color value indicated by the visual style corresponding to the target content segment comprises:
converting the pixel value of the respective pixel in the at least one reference frame into at least one of saturation or brightness;
performing a correction operation for the at least one of the saturation or the brightness respectively, such that the at least one of the corrected saturation or brightness falls within a respective threshold range; and
determining the color value indicated by the visual style based on the at least one of the corrected saturation or brightness.

14. The electronic device of claim 8, wherein the media content comprises a video.

15. A non-transitory computer-readable storage medium having computer-executable instructions stored thereon, the computer-executable instructions being executable by a processor to implement acts comprising:
presenting media content and a progress bar corresponding to the media content, a visual style of the progress bar being determined based on a content segment corresponding to a playback progress of the media content; and
switching, in response to playback from a first content segment of the media content to a second content segment of the media content, the visual style of the progress bar from a first visual style corresponding to the first content segment to a second visual style corresponding to the second content segment.

16. The non-transitory computer-readable storage medium of claim 15, wherein a visual style of a part of the progress bar in the progress bar is determined based on the content segment corresponding to the playback progress of the media content.

17. The non-transitory computer-readable storage medium of claim 15, wherein switching the visual style of the progress bar from the first visual style corresponding to the first content segment to the second visual style corresponding to the second content segment comprises:
obtaining segmentation information and visual information corresponding to the media content, the segmentation information indicating a division of a plurality of content segments in the media content, and the visual information indicating a visual style of each of the plurality of content segments;
determining the second visual style corresponding to the second content segment based on the segmentation information and the visual information; and
switching the visual style of the progress bar from the first visual style to the second visual style.

18. The non-transitory computer-readable storage medium of claim 15, wherein a visual style corresponding to a target content segment in the media content is determined by:
selecting at least one reference frame from the target content segment; and
determining the visual style corresponding to the target content segment based on a visual style corresponding to the at least one reference frame,
wherein the target content segment comprises the first content segment or the second content segment.

19. The non-transitory computer-readable storage medium of claim 18, wherein the visual style corresponding to the target content segment indicates a color value, and wherein determining the visual style corresponding to presenting the target content segment comprises:
determining the color value indicated by the visual style corresponding to the target content segment based on a pixel value of a respective pixel in the at least one reference frame.

20. The non-transitory computer-readable storage medium of claim 19, wherein determining the color value indicated by the visual style corresponding to the target content segment comprises:
converting the pixel value of the respective pixel in the at least one reference frame into at least one of saturation or brightness;
performing a correction operation for the at least one of the saturation or the brightness respectively, such that the at least one of the corrected saturation or brightness falls within a respective threshold range; and
determining the color value indicated by the visual style based on the at least one of the corrected saturation or brightness.
